(19) United States
(12) Patent Application Publication
(10) Pub. No.: US 2005/0218611 A1
(43) Pub. Date: Oct. 6, 2005

(54) Carving soft toboggan

(76) Inventor: Charles F. Mehrmann, Woodinville, WA (US)

Correspondence Address: DEAN A.CRAINE, STE 140, 400 - 112TH AVE NE, BELLEVUE, WA, 98004, US

(21) Appl. No.: 10/818,682

(22) Filed: Apr. 6, 2004

(51) Int. Cl. B62B 9/04

(52) U.S. Cl. 280/18

(57) ABSTRACT

A lightweight toboggan capable of being used by small children and adults that includes a runner surface made of sufficiently durable material for repeated use and an upper foam shell for greater comfort and injury protection. The toboggan is also designed for greater tracking and steering. The above objects are met by using a toboggan that includes a lower runner shell made of hard plastic, such as ABS or high density polyethylene that includes two curved side cuts formed on the opposite sidewalls and an optional V-shaped center tunnel. The two side cuts are located in parallel to the direction of travel on the edge of the riding surface so that they do not engage the snow or ice surface when the toboggan is flat and ridden in a straight line. When the rider leans and lifts one side of the toboggan, the opposite side cut is rotated downward to engage the snow or ice causing the toboggan to turn. The perimeter edges of the lower runner shell and the upper foam shell are coupled together to create an aesthetically pleasing seam that resists delamination. The upper foam shell substantially reduces the toboggan's weight, serves to protect and hide the channels and arcs, and provides greater comfort and edge protection with impacts.

### BACKGROUND OF THE INVENTION

1. Field of the Invention

This invention pertains to toboggans and more particularly, to lightweight toboggans partially made of foam that enables the occupant to easily flex and distort the toboggan to turn.

2. Description of the Related Art

Toboggans commonly have a recessed central tunnel located longitudinally on their bottom surface that enables the toboggan to track in a straight line. Because the bottom runner of the toboggan or snowboard slides over packed snow or ice, toboggans are designed to be ridden over several seasons and must be made of sufficiently durable material, such as metal or plastic.

Toboggans made of lightweight foam have recently been developed, (see U.S. Pat. No. D476,921) that can be easily pulled up snow covered hills by small children. Unfortunately, foam toboggans are not sufficiently durable and are usually discarded after one season. While toboggans made of metal or hard plastic may be more durable, they are also substantially heavier and cause greater impact injuries.

Because toboggans have a flat bottom surface that makes them difficult to steer, they are commonly ridden in straight paths on small gentle slopes.

### SUMMARY OF THE INVENTION

It is an object of the present invention to provide a lightweight toboggan that can be easily carried or pulled by small children.

It is another object of the invention to provide such a toboggan that has a bottom surface made of sufficiently durable material for repeated use.

It is another object of the invention to provide such a toboggan that includes an upper, soft foam support surface for seating that absorbs impacts during use and allows the user to selectively deform the shape of the toboggan's runner surfaces.

These and other objects of the invention, the toboggan disclosed herein that includes a flexible lower runner shell connected to a flexible, upper soft foam shell. The lower runner shell is lightweight basin-shaped structure with two upward extending sidewalls, a forward extending front wall, a vertically aligned rear wall, and a flat bottom surface. The sidewalls, front wall, rear wall and bottom surface are made of resilient, relatively thin material thereby enabling the runner shell to be deformed during use. Formed on the upper sections of the two sidewalls, front wall and rear wall is a continuous hand rail. Formed below hand rail located is a finger cavity in which the occupant's fingers extend to grip and lift the sidewall, front wall, and rear wall to lean and turn the toboggan.

Formed along the adjacent edges between the two sidewalls and the bottom surface are two longitudinally aligned side cuts. In the preferred embodiment, the two side cuts form two identical arcs on the opposite sides of the bottom surface. As seen in a bottom plan view, the two side cuts form the outer perimeter edges of the bottom surface thereby giving it an ‘hour glass’ appearance. When the toboggan is ridden, the toboggan is tilted to one side so that the side cut located on the sidewall closest to the snow carves into the snow thereby causing the toboggan to turn.

Formed on the bottom surface is an optional center tunnel that enables the toboggan to track in a straight line. In the preferred embodiment, the center tunnel longitudinally aligned with the toboggan's longitudinal axis. When viewed in cross-section from a front to rear elevation view, the center tunnel is a recessed V-shaped structure. During use, the center tunnel exerts equal continuous side pressure against the snow on opposite sides of the toboggan's longitudinal axis thereby causing the toboggan to track in a substantially straight line.

The upper foam shell is a lightweight basin-shaped structure designed to fit inside the runner shell. During use, the upper foam shell provides a comfortable seating surface that partially absorbs impacts to the lower runner surface. The foam shell also provides resiliency that repeatedly allows the toboggan to be temporarily deformed by the occupant gripping and lifting the sidewalls, front wall or rear wall during use and then springs back into its normal shape when released. Because the upper foam shell is lightweight, the toboggan's overall weight is reduced so that a small child may easily carry or pull the toboggan. The upper foam shell is also sufficiently durable to cover any control cables or rods that may be placed over the inside surface of the lower runner shell.

During manufacturing, the two sidewalls, front wall, and rear wall of the upper foam shell extend upward and bend over the upper section of the lower runner shell's sidewalls, front wall, and rear, respectively, to form the continuous hand rail. The lower edge of the hand rail extends into a continuous gutter formed along the outer surface of the lower runner shell's sidewalls, front wall, and rear wall. A recessed cut or step is formed in the soft foam top along the outer surface of the lower edge of the upper foam shell that hides the lower edge of the upper foam shell thereby producing an aesthetically pleasing seam that also resists delamination or separation. Because the hand rail is circular in cross-section and made of flexible material, the outer surface of the hand rail protrudes outward from the sides of the toboggan and acts as a bumper that protects individuals and object that may be struck by the toboggan during use.

### DESCRIPTION OF THE DRAWINGS

FIG. 1 is a perspective view of the toboggan disclosed herein.

FIG. 2 is a top plan view of the toboggan.

FIG. 3 is a bottom plan view of the toboggan.

FIG. 4 is a side elevation view of the invention of the toboggan.

FIG. 5 is a front elevational view of the toboggan.

FIG. 6 is a front elevational view of the toboggan showing the toboggan tilted to one side to engage a side cut on one side of the toboggan.

FIG. 7 is perspective sectional view of the toboggan showing how the upper foam layer attaches to the lower runner shell.

FIG. 8 is a sectional, side elevational view taken along line 8-8 in FIG. 2.

FIG. 9 is a sectional, side elevational view taken along line 9-9 in FIG. 2.

### DESCRIPTION OF THE PREFERRED EMBODIMENT(S)

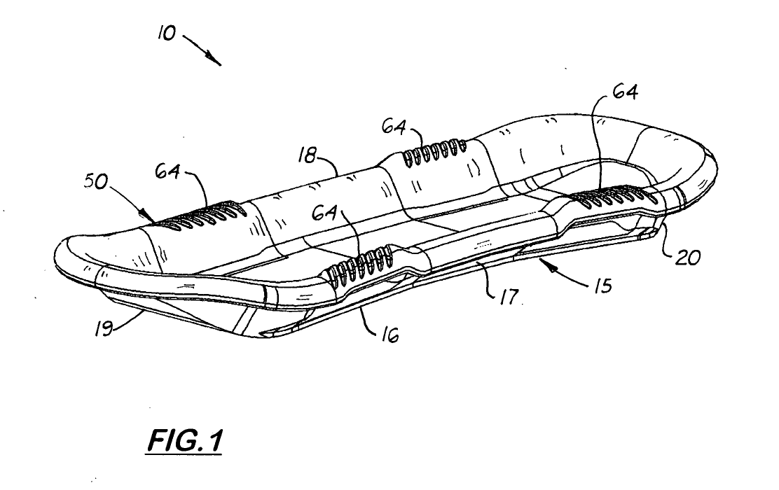

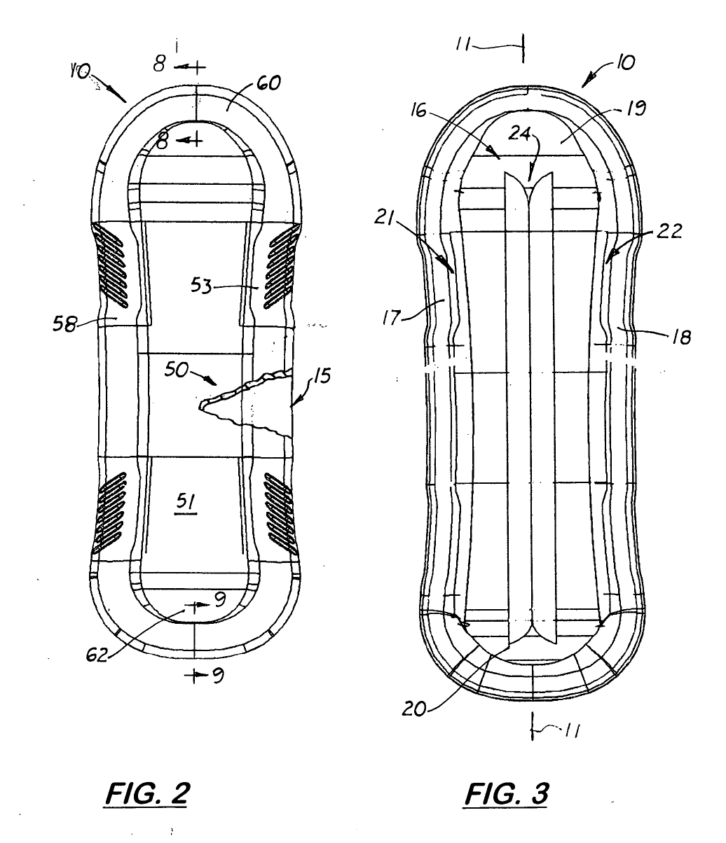

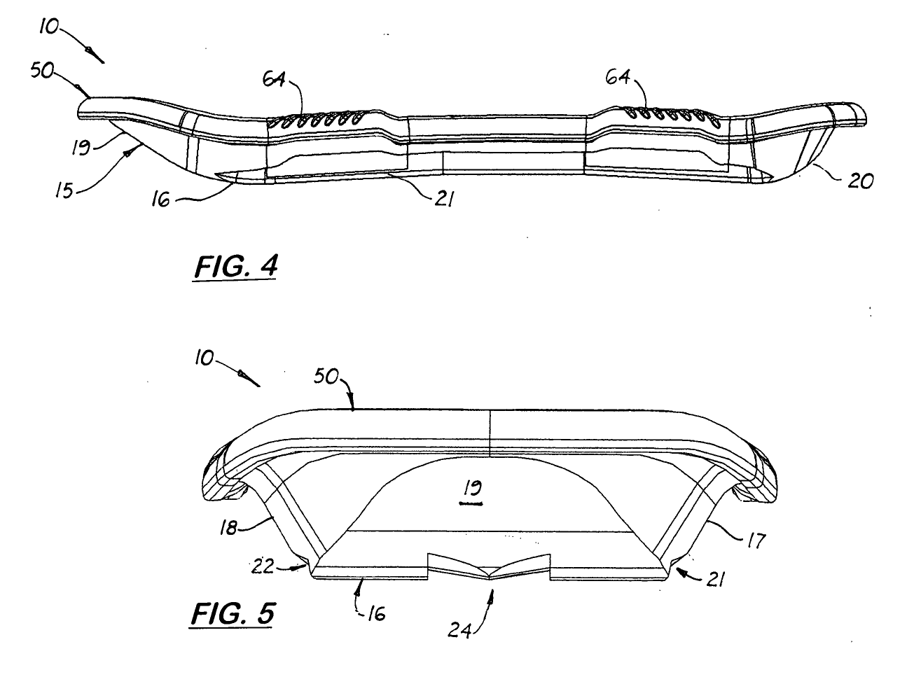

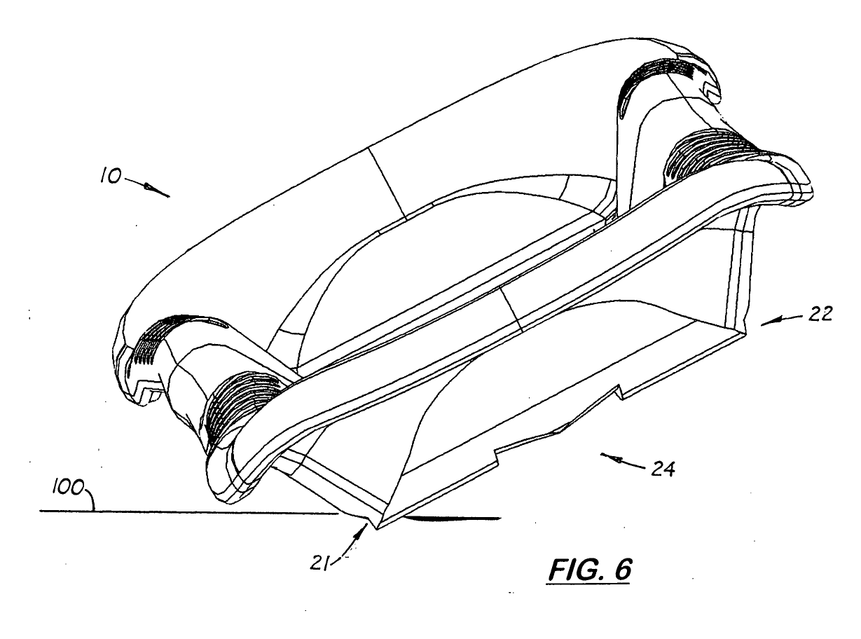

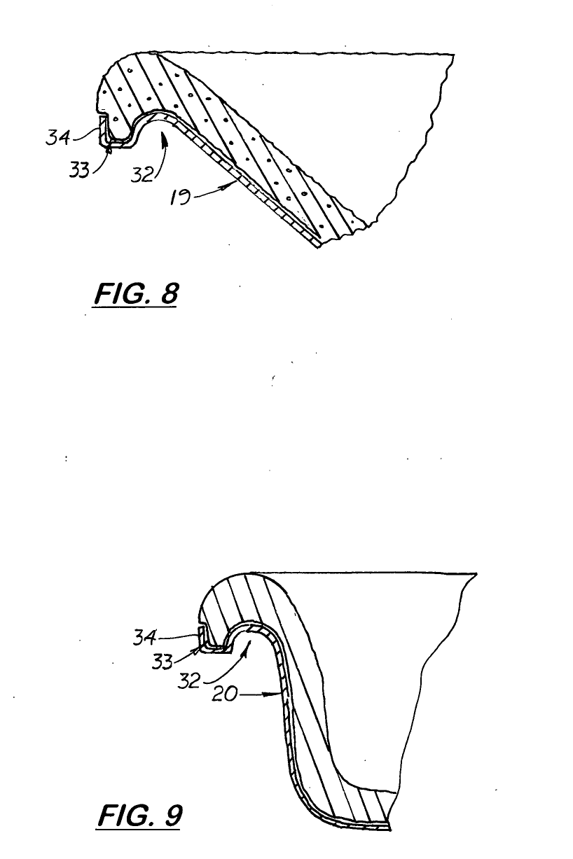

There is shown in the accompanying FIGS. 1-9, a toboggan 10 that incorporates the beneficial structures typically found on a hard shell toboggan and a soft foam toboggan. The toboggan 10 includes a flexible, lower runner shell 15 located under a soft, flexible, upper foam shell 50. The lower runner shell 15 is basin-shaped structure with a bottom surface 16 and two upward extending sidewalls 17, 18 a front wall 19, and a rear wall 20. As shown in FIG. 4, the bottom surface 16 is slight concave from front to rear and side to side with a forward sloped front wall 19 and rounded rear wall 20. All of the both sidewalls 17, 18, front wall 19, and rear wall 20 are slightly higher at their mid points that at their ends, thereby creating a basin-shape structure. As shown in FIG. 5, the bottom surface 16 is substantially flat when viewed from a front elevational view

The two sidewalls 17, 18 extend laterally and diagonally relative to the bottom surface 16. Formed on the edge between the bottom surface 16 and each sidewall 17, 18 is a longitudinally aligned side cut 21, 22, respectively. As shown in FIG. 3, the two side cuts 21, 22 extend longitudinally and continuously curve outward adjacent to the entire bottom surface 16. When viewed from a bottom plan view as shown in FIG. 3, the bottom surface 16 has an ‘hour shape’ appearance. The sidewalls 17, 18 continue upward from the side cuts 21, 22, respectively, to a second trim edge 28, 29. From the second trim edges 28, 29, the sidewalls 17, 18 extend vertically and upward to an inverted u-shaped section 31 that acts as a structural component for the hand rail 40 discussed further below.

The inverted u-shaped section 31 forms a finger cavity 32 in which the occupant's fingers extend when gripping the hand rail 40. Extending laterally from the finger cavity 32 is a gutter 33 that receives the outer perimeter edge 53 of the upper foam shell 50. Formed on the distal edge of the gutter 33 is a vertically aligned lip 34. In the preferred embodiment, the gutter 33 is formed around the entire perimeter of the hand runner shell 15. During use, the outer perimeter edge 53 and the gutter 33 acts as a mechanical locking means to connect the upper foam shell 50 to the hard runner shell 15.

Formed on the bottom surface 16 is an optional, longitudinally aligned center tunnel 24 designed to allow the toboggan 10 to track in a straight line. In the preferred embodiment, the center tunnel 24 is an elongated, recessed, V-shaped structure with two diagonal surfaces 25, 26 with an apex 27 being longitudinally aligned and registered with the toboggan's longitudinally axis 11. During use, the center tunnel 24 exerts equal continuous side pressure against the snow on opposite sides of the toboggan's longitudinal axis 11 thereby stabilizing the toboggan 10 and causing the toboggan 10 to track in a substantially straight line.

The upper foam shell 50 is a lightweight basin-like structure designed to fit inside the lower runner shell 15 to provide support and comfort to the occupant. Because, the upper foam shell 50 is lightweight, the overall weight of the toboggan 10 is reduced so that a small child may easily carry or pull the toboggan 10. During use, the upper foam shell 50 is also sufficiently durable to support the occupant yet sufficiently flexible so that the toboggan 10 may be easily titled on one sidewall 17 or 18 by the occupant and deformed to engaging one of the side cuts 21 or 22 as discussed above to turn the toboggan 10. In the preferred embodiment, the upper foam shell 50 includes a bottom surface 51, two sidewalls 53, 58, a front wall 60, and a rear wall 62. The overall size and shape of the upper foam shell 50 is sufficient so that the upper foam shell 50 fit closely inside the lower shell runner 15.

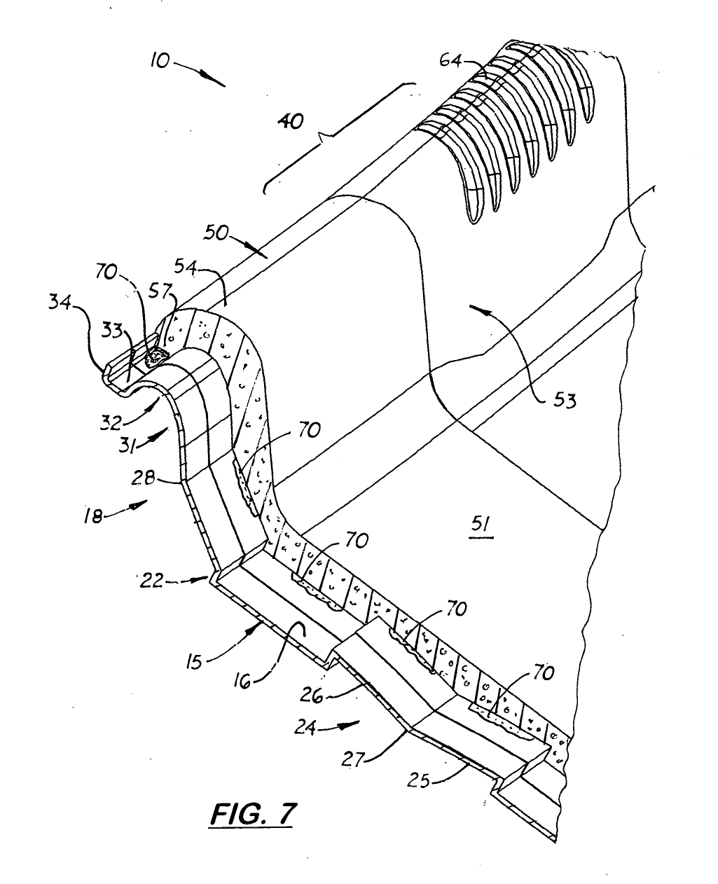

As stated above, a continuous is formed around the toboggan 10. Referring now to FIGS. 4-6, the is formed by an inverted u-shaped section formed the sidewalls 53, 58, front wall 60, and rear wall 62 that extend over the inverted u-shaped section of the sidewalls 17, 18, front wall 19, and rear wall 20, respectively. FIG. 7 is a sectional, perspective view of the toboggan 10 showing the complimentary shapes of the inverted u-shaped section 54 on the sidewall 53 disposed over the inverted u-shaped section 31 of the sidewall 17. During the manufacturing process, the foam shell 50 is aligned and registered over the lower runner shell 15 so that the perimeter edge 55 of the u-shaped section 54 extends into the gutter 33. Formed on the outer surface of the inverted u-shaped section 54 is a step 57 that receives the outer lip 34 located on the gutter 33. When upper foam shell 50 is aligned and registered over the lower runner shell 15 and the inverted u-shaped section 54 is inserted into the gutter 33 and the outer lip 34 is disposed inside the step 57, a continuous, smooth aesthetically attractive joint is created that resists delamination. Because upper foam shell 50 is made of flexible foam and the gutter 33 and outer lip 34 are continuous around the toboggan 10, upper foam shell 50 snap fits into lower runner shell 15. An optional suitable adhesive 70 may be disposed between the adjacent surfaces of the hard runner shell 15 and foam shell 50 to attach them together. When the inverted u-shaped sections are attached together a soft, comfortable, continuous 40 is formed on the toboggan 10. Formed on the outer surface of the hand rail 40 are optional hand and foot placement areas 64 designed to resist wear and tear and aid the occupant to grip the hand rail 40.

In the preferred embodiment, the toboggan 10 measures approximately 54″ in length, 20″ in width, and 6″ in height. The lower runner shell 15 is generally rigid, although it can be flexed and twisted laterally. The lower runner shell 15 is made of thin (1 mm to 5 mm thickness) material such as polyethylene, polypropelyne, polycarbonate, ABS, acrylic, fiberglass, carbon. The lower runner shell 15 is manufactured by a compression, vacuum molding, blow molding or injection molding process. The upper foam shell 50 is made of ¼″-2″ thick EVA, EPS, R-cell, polyethylene, polypropylene, polyurethane, or a blend of these materials or a combination of these materials and vacuum forming, compression molding or injection molding into a shape that fits inside the runner shell 15. The upper foam shell 50 has a density ranging from one-pound per cubic foot density to twenty-pound per cubic foot density. Once both shells 15, 50 are formed, they may be bonded together using either a suitable adhesive 70 or bonding agent, or heat lamination etc. It should be understood that the toboggan 10 be manufactured in it's entirety in one cycle by vacuum forming or compression forming the lower runner shell 15 and then compression and vacuum forming the upper foam shell 50.

During use, the toboggan 10 is placed on an icy or snowy surface. The occupant sits or lays in the recessed sitting area formed in the upper foam shell 50. The occupant's feet may be positioned inside the sitting area or extended over the sidewalls. When the occupant wants to turn the toboggan 10, the occupant leans to the desired side and then grips and lifts the opposite sidewall 17 or 18, front wall 19 or rear wall 20 which deforms the bottom surface 16. As the bottom surface 16 is deformed, the center tunnel 24 is disengaged from the icy or snowy sliding surface. The side cut 21 or 22 on the lower sidewall engages the icy or snowy surface and causes the toboggan 10 to turn in the desired direction. The flexing and distortion the toboggan 10 to simultaneously engage one side cut and, disengage the opposite side cut and the center channel 24 in combination with user applying their weight to one side, results in the toboggan 10 turning. When the occupant releases the sidewall 17 or 18, front wall 19 or rear wall 20 the toboggan springs back into its original shape and configuration and begins tracking in a straight line. The act of selectively leaning and distorting the toboggan is continued throughout the entire run.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

1. A toboggan, comprising:
a. a lower runner shell with an elongated flat runner surface and two, opposite upward extending, longitudinally aligned sidewalls each said sidewall including a gutter located around its perimeter edge;
b. two longitudinally aligned side cuts formed on said sidewalls of said runner shell, said side cuts being slightly curved outward and positioned along the edge between said sidewall and said bottom surface of said runner shell so that when said toboggan is tilted on one side, said side cut engages the sliding surface upon which said runner shell is sliding thereby causing said toboggan to turn; and,
c. an upper foam shell aligned and registered over said runner shell, said upper foam shell having a perimeter edge that engages said gutter on said runner shell.

2. The toboggan, as recited in claim 1, further including a continuous hand rail formed on said upper foam shell.

3. The toboggan, as recited in claim 1, wherein said hand rail includes a downward extending edge that engages said gutter on said runner shell.

4. The toboggan, as recited in claim 1, further including a step formed on said foam shell adjacent to said downward extending edge thereby creating an aesthetic seam the resists delamination between said foam shell and said runner shell.

5. The toboggan, as recited in claim 1, wherein said runner shell is made of rigid material 1 mm to 5 mm thick.

6. The toboggan, as recited in claim 1, wherein said foam shell is made of one of the following group of materials: EVA, EPS, R-cell, polyethylene, polypropylene, and polyurethane.

7. The toboggan, as recited in claim 1, wherein said foam shell is between ¼″-2″ thick.

8. The toboggan, as recited in claim 1, wherein said foam shell has a density between one to twenty pounds per cubic foot.

9. The toboggan, as recited in claim 1, further including a center tunnel formed longitudinally on said runner shell.

10. The toboggan, as recited in claim 9, wherein said center tunnel is recessed on said bottom surface and v-shaped in cross-section.

11. The toboggan, as recited in claim 1, further including an adhesive used to attach said runner shell and said foam shell together.

12. A toboggan, comprising:
a. a basin-shaped runner shell with an elongated flat runner surface and two, opposite upward extending, longitudinally aligned sidewalls, a front wall, and rear wall, and a bottom wall, each said sidewall including a gutter located around its perimeter edge;
b. two longitudinally aligned side cuts formed on said sidewalls of said runner shell, said side cuts being slightly curved outward and positioned along the adjoining edge between said sidewall and said bottom surface of said runner shell so that when said toboggan is tilted on one side, said side cut engages the sliding surface upon which said runner shell is sliding thereby causing said toboggan to turn;
c. a basin-shaped upper foam shell aligned and registered over said runner shell, said upper foam shell having a perimeter edge that engages said gutter on said runner shell; and,
d. an adhesive used to attach said foam shell over said runner shell.

13. The toboggan, as recited in claim 12, further including a center tunnel formed longitudinally on said runner shell.

14. The toboggan, as recited in claim 13, wherein said center tunnel is recessed on said bottom surface and v-shaped in cross-section.

15. The toboggan, as recited in claim 12, further including said gutter formed on said sidewalls, said front wall and said rear wall of said runner shell that is engaged by said foam shell to attach said foam shell to said runner shell.

16. The toboggan, as recited in claim 5, further including a center tunnel formed longitudinally on said runner shell.

17. The toboggan, as recited in claim 13, further including said gutter formed on said sidewalls, said front wall and said rear wall of said runner shell that is engaged by said foam shell to attach said foam shell to said runner shell.

18. The toboggan, as recited in claim 12, wherein said runner shell is made of rigid material 1 mm to 5 mm thick.

19. The toboggan, as recited in claim 12, wherein said foam shell is made of one of the following group of materials: EVA, EPS, R-cell, polyethylene, polypropylene, and polyurethane.

20. A toboggan, comprising:
a. a lower runner shell made of thin, durable material capable of flexing, said lower runner shell including a flat runner surface, two opposite upward extending sidewalls, a front wall and a rear wall;
b. a gutter formed on said lower runner shell; and,
c. an upper foam shell aligned and registered over said lower runner shell, said upper foam shell having a perimeter edge that engages said gutter on said runner shell to mechanically lock said upper foam shell on said lower runner shell.
